(19) United States
(12) Patent Application Publication
(10) Pub. No.: US 2010/0158706 A1
(43) Pub. Date: Jun. 24, 2010

(54) Pressure change compensation arrangement for pump actuator

(75) Inventor: Christopher M. Gruel, Edwards, IL (US)

Correspondence Address: LEYDIG, VOIT & MAYER, LTD, TWO PRUDENTIAL PLAZA SUITE 4900, 180 N. STETSON AVE, CHICAGO, IL, 60601, US

(73) Assignee: Caterpillar Inc., Peoria, IL (US)

(21) Appl. No.: 12/343,626

(22) Filed: Dec. 24, 2008

(51) Int. Cl. F04B 1/26; F15B 13/042

(52) U.S. Cl. 417/222.1; 91/447

(57) ABSTRACT

An arrangement for controlling a swash plate of a pump includes an actuator having a piston adapted to be coupled to the swash plate wherein the separates an actuator internal chamber into first and second subchambers to which first and second valve assemblies are fluidly coupled, respectively. Each valve assembly includes a housing defining an inlet port, an outlet port, and a control port fluidly connected to one of the subchambers. A valve member slidably disposed within an interior chamber selectively moves between at least two positions to direct internal flow between the ports.

### TECHNICAL FIELD

This patent disclosure relates generally to variable displacement pumps, and, more particularly to a pressure change compensation arrangement for a swash plate control for such a pump.

### BACKGROUND

Variable stroke pumps are frequently utilized in hydraulic systems to deliver hydraulic fluid under high pressure to various components of the system. Such pumps typically include a number of reciprocating pistons arranged radially around a rotating block. The full stroke length of the pistons may be varied by modifying the angle of a swash plate from which the pistons extend. Thus, the volumetric displacement of the pump varies based upon the angle of the pistons to swash plate.

The angle of the swash plate may be varied by manual operation, servo control, or compensator control. U.S. Pat. No. 5,079,919 to Nakamura et al. discloses a hydraulic drive system for a crawler mounted vehicle. The variable stroke pump of Nakamura is controlled by a pump regulator that comprises an actuator coupled to the swash plate, and two solenoid selector valves for controlling the operation of the actuator. The actuator is a double-acting cylinder unit having a piston wherein the opposite faces are of different areas. The smaller of the two faces is in constant communication with a pilot line and selective communication with a reservoir by way of two solenoid selector valves. The larger of the two faces is in selective communication with the pilot line by way of one of the solenoid selector valves, and in selective communication with the reservoir by way of the other of the solenoid selector valves. The solenoid selector valves are each two-port, two-way valves, which either allow cross flow or prevent passage.

Proportional pressure control valves, such as solenoid selector valve that may be used to provide such control, regulate fluid pressure proportional to an electric current supplied to an associated solenoid. Typically, pressure control valves include a high pressure port in communication with a supply passage, a low pressure port in communication with a tank, and a control port which delivers fluid under a pre-determined pressure to a fluid-operated device. The valve further includes a sliding valve member, biased by a spring, and configured to open and close the various fluid passages. The valve member assumes a position when the pressure at the control port and the spring force are balanced with a driving force which depends on a current level used to energize the solenoid.

Flow forces are natural phenomena in proportional pressure control valves. Flow forces, also referred to as Bernoulli's forces, result from the localized pressure drop in the small opening between the metering valve member and the valve body. More specifically, as the fluid passes through the restriction in a fluid path, the velocity of the fluid increases. In the high velocity flow, the kinetic energy increases at the expense of the pressure energy, reducing the pressure adjacent the small opening. The localized pressure drop is attributed to inducing a pressure gradient across the body of the metering valve member, and generates a flow force acting on the valve member in the axial direction. The flow force tends to close the valve, thereby reducing the overall performance of the valve.

Thus, such pressure control valves inherently include flow induced pressure errors that may result in a pressure drop across a pump actuator. Accordingly, movement of a pump actuator based upon the use of a pair of valves may result in particular difficulty in controlling such a pressure drop. Accordingly, it is desirable to provide a control arrangement that addresses one or more of the shortcomings of the prior art.

### SUMMARY

The disclosure describes, in one aspect, an arrangement for controlling a swash plate of a pump. The arrangement comprises an actuator adapted to be coupled to the swash plate. The actuator includes a housing defining an internal chamber, a piston movably disposed within the chamber and separating the chamber into at least a first subchamber and a second subchamber, and first and second pressure control valve assemblies. Each of the valve assemblies includes a valve housing defining an interior chamber and a valve member disposed within the interior chamber. The valve housing includes at least an inlet port, an outlet port, and a control port. The control port of the first pressure control valve assembly is fluidly coupled to the first subchamber, and the control port of the second pressure control valve assembly is fluidly coupled to the second subchamber. Each valve member is selectively moveable between at least a first valve member position directing flow from the control port to the outlet port, and a second valve member position directing flow from the inlet port to the control port.

The disclosure describe, in another aspect, a hydraulic system comprising a source of high pressure fluid, a lower pressure tank, a pump including a swash plate, and an actuator coupled to the swash plate. The actuator includes a cylinder defining an internal chamber, and a piston movably disposed within the chamber and separating the chamber into at least a first subchamber and a second subchamber. The system further includes first and second pressure control valve assemblies fluidly coupled to the first and second subchambers, respectively. Each of the valve assemblies is coupled to the source of high pressure fluid and the lower pressure tank. Each of the valve assemblies includes a valve member and at least three ports. The valve member is selectively moveable between at least first and second valve member positions. The first valve position directs flow from the respective subchamber to the lower pressure tank. The second valve position directs flow from the source of high pressure fluid to the respective subchamber.

In another aspect, the disclosure describes a method of controlling a swash plate of a pump. The method comprises the step of coupling an actuator to the swash plate. The actuator includes a housing defining an internal chamber, and a piston movably disposed within the chamber and separating the chamber into at least a first subchamber and a second subchamber. The method also includes the steps of fluidly coupling a first control port of a first pressure control valve assembly to the first subchamber, and fluidly coupling a second control port of a second pressure control valve assembly to the second subchamber. The first valve assembly includes a first valve housing defining a first interior chamber and a first valve member disposed within the first interior chamber. The first valve housing includes at least the first control port, a first inlet port, and a first outlet port. The second valve assembly includes a second valve housing defining a second interior chamber and a second valve member disposed within the second interior chamber. The second valve housing includes at least the second control port, a second inlet port, and a second outlet port. The method further includes the steps of moving the first valve member to a first valve member position of the first valve member directing flow from the first control port to the first outlet port, moving the second valve member to a second valve member position of the second valve member directing flow from the second inlet port to the second control port, moving the second valve member to a first valve member position of the second valve member directing flow from the second control port to the second outlet port, and moving the first valve member to a second valve member position of the first valve member directing flow from the first inlet port to the first control port.

### BRIEF DESCRIPTION OF THE DRAWING(S)

FIG. 1 is an exemplary, fragmentary schematic drawing of a variable displacement pump and an associated actuator.

FIG. 2 is a fragmentary hydraulic circuit diagram of the arrangement of FIG. 1.

FIG. 3 illustrates exemplary flow/pressure maps of a static pressure differential across a representative actuator in an uncorrected system.

FIG. 4 illustrates exemplary flow/pressure maps of a dynamic pressure differential across a representative actuator in an uncorrected system.

FIG. 5 illustrates exemplary flow/pressure maps of a static pressure differential across a representative actuator in a corrected system.

FIG. 6 illustrates exemplary flow/pressure maps of a dynamic pressure differential across a representative actuator in a corrected system.

FIG. 7 is a diagrammatic illustration of a hydraulic system illustrating a valve assembly positioned for fluid flow between an inlet port and a control port.

FIG. 8 is a diagrammatic illustration of the hydraulic system of FIG. 7 illustrating the valve assembly positioned for fluid flow between the control port and an outlet port.

### DETAILED DESCRIPTION

This disclosure relates to the structure and operation of variable displacement pumps, and, more specifically, to a pump actuator piston utilized to control the swash plate in such pumps. Such arrangements may be utilized in hydrostatically operated machines, such as, for example, any machine that performs some type of operation associated with an industry such as mining, construction, farming, transportation, or any other industry known in the art. For example, a machine may be an earth-moving machine, such as a wheel loader, excavator, backhoe, motor grader, material handler or the like, and, in particular, any machine that includes a rear mounted engine. One or more implements may be connected to the machine, and may be utilized for a variety of tasks, including, for example, brushing, compacting, grading, lifting, loading, plowing, ripping, and include, for example, augers, blades, breakers/hammers, brushes, buckets, compactors, cutters, forked lifting devices, grader bits and end bits, grapples, blades, rippers, scarifiers, shears, snow plows, snow wings, and others.

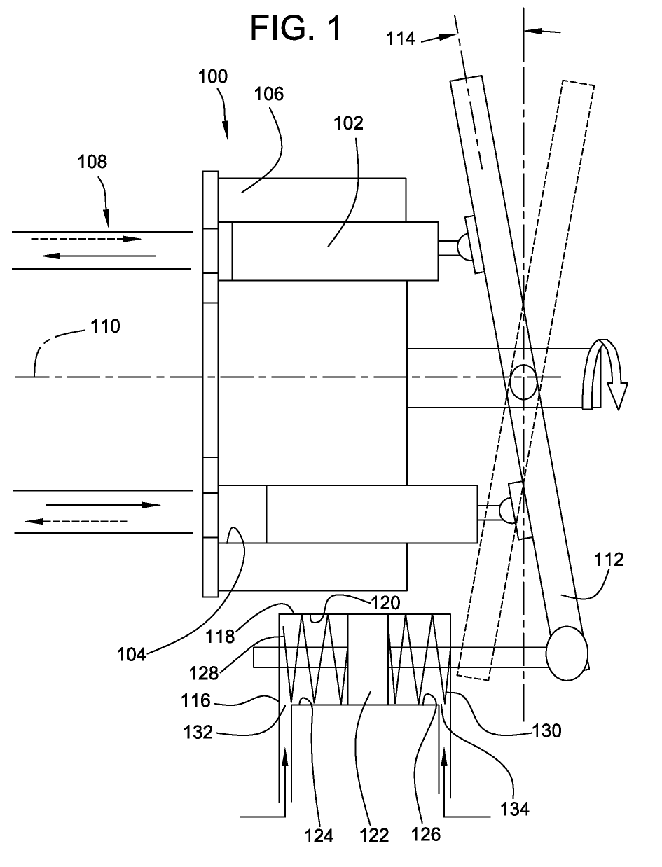

Turning now to FIG. 1, there is shown an exemplary, fragmentary schematic drawing of a variable displacement pump 100. The pump 100 includes a plurality of pistons 102 disposed to reciprocate back and forth in corresponding cylinder bores 104 in a cylinder block 106 to cause the displacement of hydraulic fluid through high pressure fluid passages (indicated generally as 108) as the block 106 rotates about an axis 110. In a variable displacement pump 100, such as the one illustrated, the distances along which the pistons 102 travel is controlled by the angle of a movable pump swash plate 112. Thus, the fluid displacement of the pistons 102, and, therefore, the pump 100, may be varied by modifying the swash plate angle 114.

In order to modify the swash plate angle 114, an actuator 116 is provided. The actuator 116 includes a cylinder or housing 118 defining an internal chamber 120 in which piston 122 is movably disposed. The swash plate angle 114 may be modified by axially moving the piston 122 in one direction or the other. The piston 122 separates the internal chamber 120 of the actuator into at least a first subchamber 124 and a second subchamber 126. Biasing means, such as, for example, springs 128, 130 may be provided to bias the piston 122 to a desired position within the chamber 120. Ports 132, 134 permit the application of hydraulic fluid to the first and second subchambers 124, 126, respectively, in order to move the piston 122 in either direction within the internal chamber 120. In this way, by applying fluid to or removing fluid from the subchambers 124, 126, the angle 114 of the swash plate 112 may be varied to adjust the pump 100 displacement.

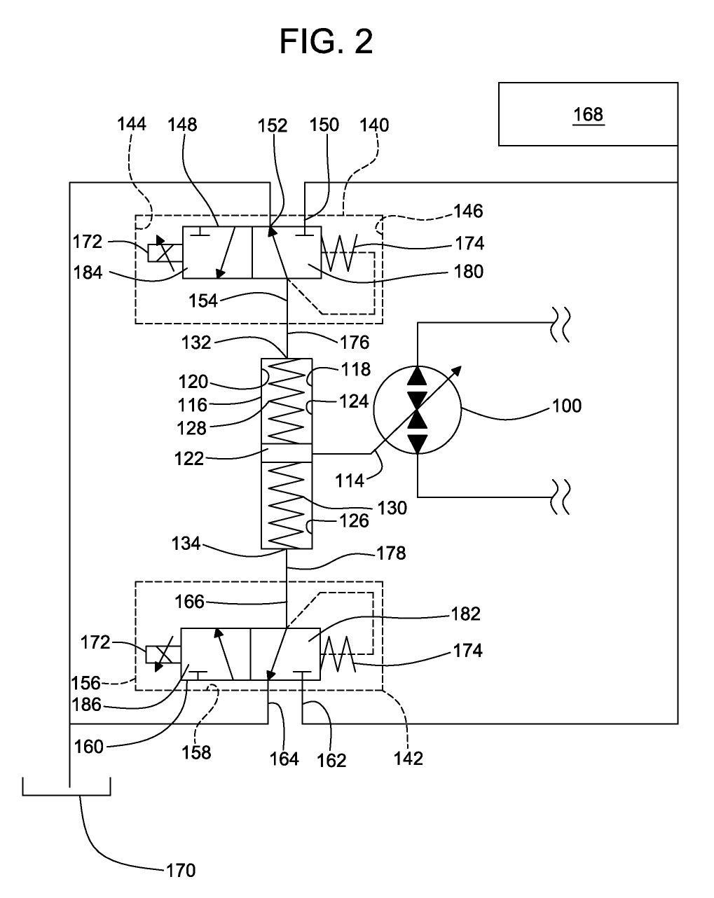

Turning to FIG. 2, there is shown a fragmentary hydraulic circuit diagram of an exemplary arrangement including the variable displacement pump 100 of FIG. 1. According to the disclosure, first and second pressure control valve assemblies 140, 142 are fluidly coupled to the first and second subchambers 124, 126, respectively. The valve assemblies 140, 142, shown schematically in FIG. 2, are of any appropriate design. For example, as will be understood by those of skill in the art, the valve assembly 140 includes a valve housing 144 that defines an interior chamber 146 (the housing 144 and interior chamber 146 are shown schematically) in which a valve member 148 is movably disposed. The valve housing 144 include three ports, that is, an inlet port 150, an outlet port 152, and a control port 154. Similarly, the valve assembly 142 includes a valve housing 156 that defines an interior chamber 158 (again, the housing 156 and interior chamber 158 are shown schematically) in which a valve member 160 is movably disposed. The valve housing 156 likewise includes an inlet port 162, an outlet port 164, and a control port 166.

The inlet port 150, 162 of each valve assembly 140, 142 is fluidly coupled to a source of high pressure fluid or supply oil 168, while the outlet ports 152, 164 are fluidly coupled to a source of low pressure fluid, reservoir or drain 170. The control port 154 of the first pressure control valve assembly 140 is fluidly coupled to the first subchamber 124 of the actuator 116 by way of the port 132, while the control port 166 of the second pressure control valve assembly 142 is fluidly coupled to the second subchamber 126 of the actuator 116 by way of the port 134.

The valve member 148, 160 of each valve assembly 140, 142 is selectively movable between first and second valve member positions. In the illustrated embodiment, the valve assemblies 140, 142 are solenoid 172 operated with a spring 174 return; the valves assemblies 140, 142 are subjected to pressure of the respective side of the actuator 116 by lines 176, 178, respectively. In this way, an electrical command provided to the valve assemblies 140, 142 sets a control pressure on each side of the actuator 116. Alternate valve control arrangements may be utilized.

The first valve member position 180, 182 for each of the valve assemblies 140, 142 is illustrated in FIG. 2. That is, in the first position 180, 182 for each of the valve assemblies 140, 142, flow is directed away from the respective subchamber 124, 126 through the respective control port 154, 166 to the respective outlet port 152, 164 and to the drain 170. In the second position 184, 186 for each of the valve assemblies 140, 142, flow is directed from the source of supply oil 168 through the respective inlet port 150, 162, and the respective control port 154, 166 to the respective subchamber 124, 126.

In use, the first valve assembly 140 would be in the first position 180, while the second valve assembly 142 would be in the second position 186, and, conversely, the second valve assembly 142 would be in the first position 182, while the first valve assembly 140 would be in the second position 184. In this way, in order to move or position the piston 122 in one direction or the other so as to move the associated swash plate 112, one of the valve assemblies would direct fluid flow and pressure toward its associated subchamber, while the other of the valve assemblies would direct fluid flow away from its associated subchamber.

When the actuator 116 is not moving there is typically little to no flow across the valve assemblies 140, 142. When the actuator 116 is moving for whatever reason, however, hydraulic fluid will flow through the valve assemblies 140, 142. In this way, one of the valve assemblies 140, 142 will be filling a respective subchamber 124, 126 of the actuator 116, while the other of the valve assemblies 140, 142 will be draining its respective subchamber 124, 126 of the actuator 116.

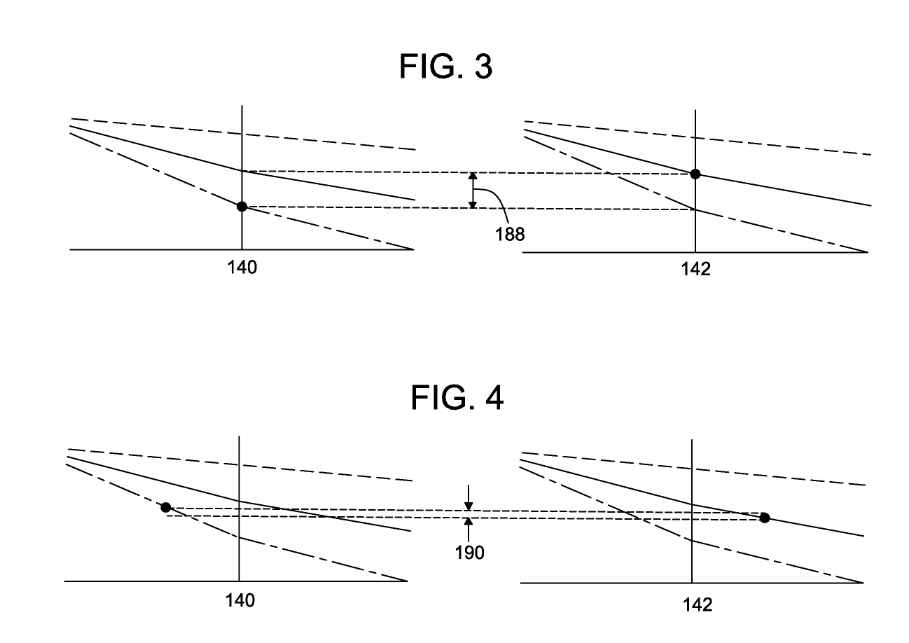

The pressure drops through the respective valves assemblies 140, 142 due to the flow therethrough may result in errors in the control pressure on either side of the actuator 116 from static to dynamic conditions. The shape of the flow map of a valve assembly dictates the flow induced error. FIGS. 3 and 4 illustrate exemplary flow maps of valve assemblies 140 (left) and 142 (right) during three respective valve control pressure commands. The three different valve control pressure commands are identified by dotted, solid, and dot/dash lines, respectively. In each flow map, the vertical axis shows the control pressure for the associated valve assembly 140, 142; the horizontal axis to the left of the vertical axis shows flow from the actuator 116 to the respective valve assembly 140, 142, while the horizontal axis to the right of the vertical axis shows flow from the respective valve assembly 140, 142 to the actuator 116. In each flow map, there is no flow to or from the actuator 116 along the vertical axis.

Referring to FIG. 3, those of skill in the art will appreciate that under static valve assembly 140, 142 conditions, a static pressure differential (as indicated by reference numeral 188 in FIG. 3) is created across the actuator 116 when the first valve assembly 140 operates according to the third (dot/dash line) valve control pressure command, and the second valve assembly 142 operates according to the second (solid line) valve control pressure command. The dynamic pressure differential (as indicated by reference numeral 190) is illustrated in FIG. 4 for these same valve control pressure commands for the valve assemblies 140, 142 under dynamic conditions, that is, when flow is proceed to valve assembly 140 from the actuator 116, and to the actuator 116 from the valve assembly 142. It is noted that a relatively large error in the pressure differential results across the actuator 116, the pressure differential actually inverting in this example.

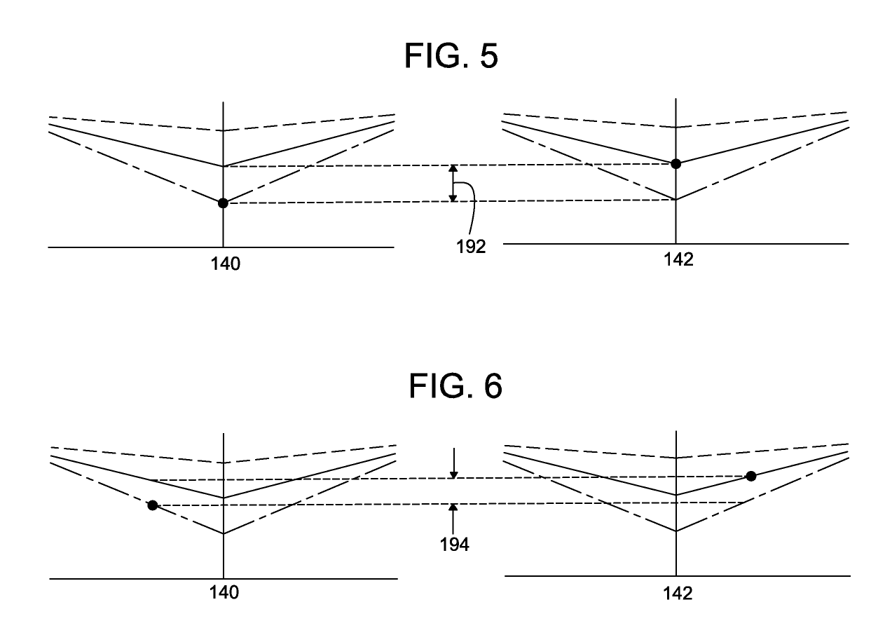

According to an aspect of the disclosure, however, the valve assemblies 140, 142 may be designed such that one side of the flow map is altered to offset the other side in order to minimize this control pressure error resulting from flow through the valve assemblies 140, 142. FIGS. 5 and 6 illustrate exemplary pressure diagrams of a static pressure differential across a representative actuator in a flow corrected system.

As with FIGS. 3 and 4, FIGS. 5 and 6 illustrate exemplary flow maps of valve assemblies 140 (left) and 142 (right) during three respective valve control pressure commands. The three different valve control pressure commands are identified by dotted, solid, and dot/dash lines, respectively. In each flow map, the vertical axis shows the control pressure for the associated valve assembly 140, 142; the horizontal axis to the left of the vertical axis shows flow from the actuator 116 to the respective valve assembly 140, 142, while the horizontal axis to the right of the vertical axis shows flow from the respective valve assembly 140, 142 to the actuator 116. In each flow map, there is no flow to or from the actuator 116 along the vertical axis.

Referring to FIG. 5, under static valve assembly 140, 142 conditions, a static pressure differential (as indicated by reference numeral 192 in FIG. 5) is created across the actuator 116 with the first valve assembly 140 for the third (dot/dash line) valve control pressure command, and the second valve assembly 142 for the second (solid line) valve control pressure command. The dynamic pressure differential (as indicated by reference numeral 194) is illustrated in FIG. 6 for these same valve control pressure commands of the valve assemblies 140, 142 under dynamic conditions, that is, when flow is proceed to valve assembly 140 from the actuator 116 (see left side of flow map for 140), and to the actuator 116 from the valve assembly 142 (see right side of flow map for 142). It is noted that the resultant pressure differentials 192, 194 across the actuator 116 are very close, that is, there is minimal difference or error between the pressure differential 192 under static conditions and the pressure differential 194 under dynamic conditions.

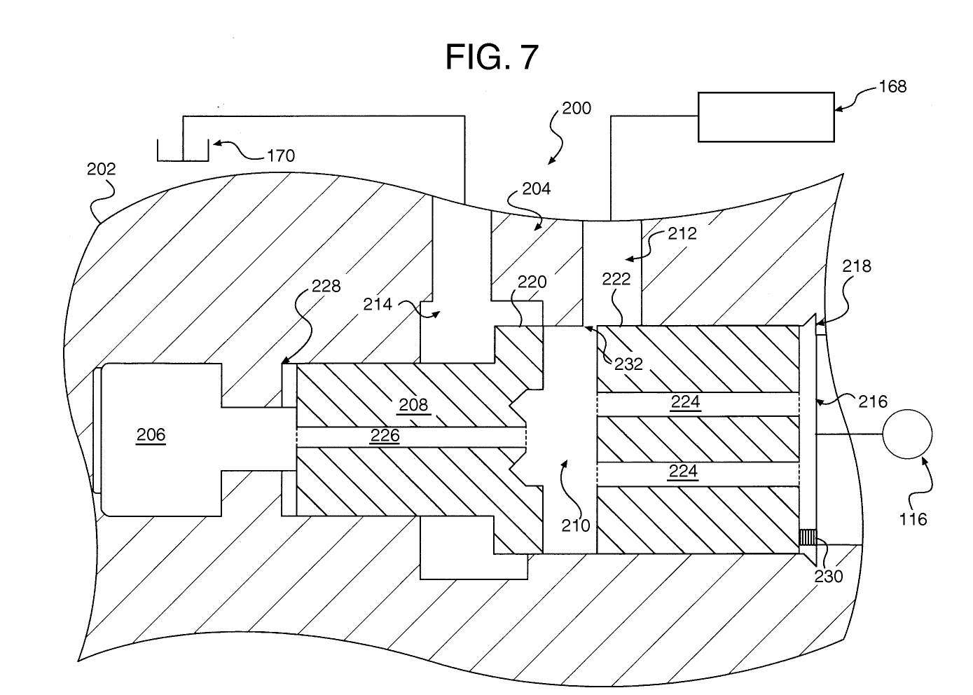

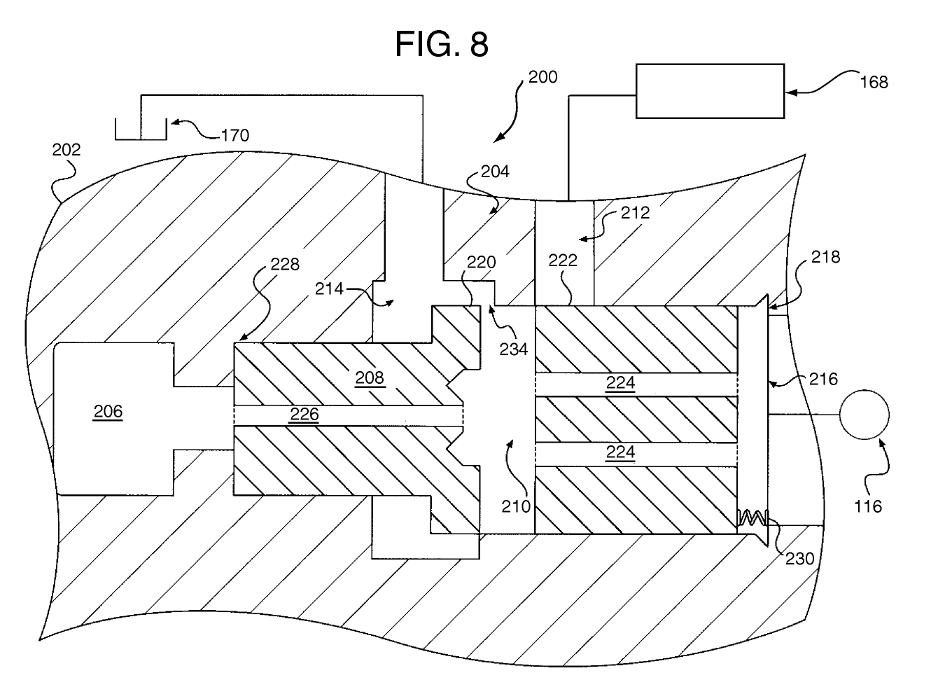

In order to provide the desired the flow maps of the valve assemblies 140, 142 and, accordingly, minimize flow induced pressure errors, any appropriate design of valve assembly 140, 142 may be utilized. One such arrangement was disclosed, for example, in U.S. patent application Ser. No. 12/010,986, which is likewise assigned to the assignee of this application. FIGS. 7 and 8 diagrammatically illustrate an exemplary embodiment of such a hydraulic system 200 including an example of such a valve assembly 202. In particular, hydraulic system 200 may include a source of supply oil 168, a drain 170, the actuator 116, and the valve assembly 302 fluidly connected to each.

FIGS. 7 and 8 depict a portion of the valve assembly 202, which includes a valve housing 204, a solenoid or other actuator 206, and a valve member 208 slidably disposed within an interior chamber 210 of the housing 204. Valve housing 204 includes a plurality of ports positioned on the longitudinal axis of the housing 204 in flow communication with the interior chamber 210. In the illustrated embodiment, the valve housing 204 includes an inlet port 212 configured to provide flow communication between the source 168 and interior chamber 210, an outlet port 214 configured to provide flow communication between the interior chamber 210 and the drain 170, and a control port 216 in flow communication with a first end 218 of the interior chamber 210 of valve housing 204. Control port 216 is configured to deliver hydraulic fluid to the actuator 116.

The valve member 208 is slidably disposed within interior chamber 210 of valve housing 204 and configured to control fluid flow therein. The valve member 208 may be of any appropriate design to provide for controlling fluid flow between the inlet port 212, the outlet port 214, and the control port 216. In the illustrated embodiment, the valve member 208 is a spool type valve member having control surfaces 220, 222 that slide against the interior surface of valve housing 204 and present varying resistance to flow through interior chamber 210 as the valve member 208 moves along the longitudinal axis, here, cooperating with the inlet port 212 and the outlet port 214 to control fluid passage.

The illustrated valve member 208 includes at least one longitudinally extending passageway or orifice 224 that may be of any appropriate design. Here, a plurality of such orifices 224 are provided, each an elongate passageway disposed in the body of valve member 208, concentric with valve member 208, although an alternate number or a single orifice 224 may be provided. It is contemplated that orifice 224 may include various cross-sectional shapes. As illustrated, the orifice 224 is located in the flow path between one of the inlet port 212 and the outlet port 214 and the control port 216. Orifice 224 may be configured to provide a restriction in the flow path generating a pressure differential therein.

The valve member 208 may additionally include a bore 226 in the body of the valve member 208, as illustrated herein. The bore 226 may be configured to dampen the movement of the valve member 208 within interior chamber 210. The bore 226 may be further configured to communicate the pressure differential generated by orifice 224 to the portion of the valve member 208 located adjacent to the solenoid 206. The solenoid or other actuator 206 operates to drive the valve member 208 in a desired position to control fluid flow through the valve assembly 202. In the illustrated embodiment, a spring 230 is provided to bias the valve member 208 in a given position to oppose the driving of solenoid 206. The spring 230 exerts a force on valve member 208, which, coupled with a pressure force at control port 216, may drive valve member 208 towards second end 228 of interior chamber 210.

In use, the solenoid 206 may drive valve member 208 to the position shown in FIG. 7 such that a first opening 232 is created between valve housing 204 and valve member 208 to allow fluid to flow in a first direction between the inlet port 212 and the control port 216. In this way, the valve member 208 is positioned such that outlet port 214 is substantially blocked to prevent fluid flow therethrough. Orifice 224 of valve member 208 may be downstream of first opening 232 and upstream of control port 216. Orifice 224 may be situated in the flow path between the inlet port 212 and the control port 216 such that fluid may flow therein.

An alternate position of the valve member 208 is illustrated in FIG. 8. In FIG. 8, a high pressure at control port 216 coupled with the spring force associated with the spring 230 overcomes the force applied by the solenoid 206 to drive the valve member 208 toward the second end 228 of the interior chamber 210. In an alternative embodiment, current supplied to the actuator 206 may be turned off to allow the spring force of the spring 230 to drive the valve member 208 towards the second end 228. In such instances a second opening 234 is created between the valve housing 204 and the valve member 208 to allow fluid to flow in a second direction between the control port 216 and the outlet port 214. The valve member 208 is positioned such that inlet port 212 is substantially blocked to prevent fluid flow there through. In this exemplary embodiment, the orifice 224 of the valve member 208 may be downstream of control port 216 and upstream of second opening 234. The orifice 224 may be situated in the flow path between the control port 216 and outlet port 214 such that fluid may flow through orifice 224.

The disclosed valve assembly 202 provides one example of a valve assembly design that may be utilized in the arrangement of FIG. 2 to modify the flow induced error generated from the flow of pressurized fluid in the valve assemblies. In this regard, the valve assembly 202 is merely illustrative of a number of valve designs and valve design parameters that may be modified to alter the flow induced pressure errors in the operation of the actuator 116.

### INDUSTRIAL APPLICABILITY

The present disclosure is applicable to system designs wherein operation of one valve assembly opposes the operation of another valve assembly. In this way, in some embodiments, the instability of one valve assembly is counteracted by the stability of the opposite valve. As a result, in some embodiments, the system may remain stable, and the flow induced error may be minimized.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

I claim:

1. Arrangement for controlling a swash plate of a pump, the arrangement comprising:
an actuator adapted to be coupled to the swash plate, the actuator including
a housing defining an internal chamber, and
a piston movably disposed within the chamber and separating the chamber into at least a first subchamber and a second subchamber, and
first and second pressure control valve assemblies, each of said valve assemblies including a valve housing defining an interior chamber and a valve member disposed within the interior chamber, the valve housing including at least an inlet port, an outlet port, and a control port, the control port of the first pressure control valve assembly being fluidly coupled to the first subchamber and the control port of the second pressure control valve assembly being fluidly coupled to the second subchamber, each said valve member being selectively moveable between at least a first valve member position directing flow from the control port to the outlet port, and a second valve member position directing flow from the inlet port to the control port.

2. The arrangement of claim 1 wherein the valve member of at least one of the valve assemblies includes at least one passageway configured to direct fluid from the inlet port to the control port.

3. The arrangement of claim 2 wherein the passageway is configured to generate a pressure differential.

4. The arrangement of claim 2 wherein the passageway is a longitudinally extending orifice.

5. The arrangement of claim 1 wherein at least one of the pressure control valve assemblies includes an actuator adapted to move the associated valve member to each of the first and second positions.

6. The arrangement of claim 5 wherein the actuator is a solenoid.

7. The arrangement of claim 6 further including a spring biasing the associated valve member against the driving force of the solenoid.

8. The arrangement of claim 1 wherein a flow map of at least one of the valve assemblies is modified to minimize flow induced pressure errors.

9. A hydraulic system comprising:
a source of high pressure fluid,
a lower pressure tank,
a pump including a swash plate,
an actuator coupled to the swash plate, the actuator including
a cylinder defining an internal chamber, and
a piston movably disposed within the chamber and separating the chamber into at least a first subchamber and a second subchamber, and
first and second pressure control valve assemblies fluidly coupled to the first and second subchambers, respectively, each of said valve assemblies being coupled to the source of high pressure fluid and the lower pressure tank, each of said valve assemblies including a valve member and at least three ports, the valve member being selectively moveable between at least first and second valve member positions, the first valve position directing flow from the respective subchamber to the lower pressure tank, the second valve position directing flow from the source of high pressure fluid to the respective subchamber.

10. The hydraulic system of claim 9 wherein each of said valve assemblies includes a valve housing defining an interior chamber, the respective valve member being disposed within the interior chamber, the valve housing including the at least three ports, the at least three ports including an inlet port, an outlet port, and a control port, the control port of the first pressure control valve assembly being fluidly coupled to the first subchamber and the control port of the second pressure control valve assembly being fluidly coupled to the second subchamber, the first valve member position directing flow from the control port to the outlet port, and the second valve member position directing flow from the inlet port to the control port.

11. The hydraulic system of claim 10 wherein the valve member of at least one of the valve assemblies includes at least one passageway configured to direct fluid from the inlet port to the control port.

12. The hydraulic system of claim 11 wherein the passageway is configured to generate a pressure differential.

13. The hydraulic system of claim 11 wherein the passageway is a longitudinally extending orifice.

14. The hydraulic system of claim 9 wherein at least one of the pressure control valve assemblies includes an actuator adapted to move the associated valve member to each of the first and second valve member positions.

15. The hydraulic system of claim 9 wherein a flow map of at least one of the valve assemblies is modified to minimize flow induced pressure errors.

16. A method of controlling a swash plate of a pump comprising the steps of
coupling an actuator to the swash plate, the actuator including
a housing defining an internal chamber, and
a piston movably disposed within the chamber and separating the chamber into at least a first subchamber and a second subchamber, and
fluidly coupling a first control port of a first pressure control valve assembly to the first subchamber, said first valve assembly including a first valve housing defining a first interior chamber and a first valve member disposed within the first interior chamber, the first valve housing including at least the first control port, a first inlet port, and a first outlet port,
fluidly coupling a second control port of a second pressure control valve assembly to the second subchamber, said second valve assembly including a second valve housing defining a second interior chamber and a second valve member disposed within the second interior chamber, the second valve housing including at least the second control port, a second inlet port, and a second outlet port,
moving the first valve member to a first valve member position of the first valve member directing flow from the first control port to the first outlet port,
moving the second valve member to a second valve member position of the second valve member directing flow from the second inlet port to the second control port,
moving the second valve member to a first valve member position of the second valve member directing flow from the second control port to the second outlet port,
moving the first valve member to a second valve member position of the first valve member directing flow from the first inlet port to the first control port.

17. The method of claim 16 further including the step of providing at least one of the first or second valve members with at least one passageway configured to direct fluid from the first or second inlet port, respectively, to the first or second control port, respectively.

18. The method of claim 17 wherein the passageway is configured to generate a pressure differential.

19. The method of claim 17 wherein the passageway is a longitudinally extending orifice.

20. The method of claim 16 further including the step of modify a flow map of at least one of the valve assemblies to minimize flow induce pressure errors.
